(19) United States
(12) Patent Application Publication
(10) Pub. No.: US 2021/0187850 A1
(43) Pub. Date: Jun. 24, 2021

(54) HEATING ELEMENT ASSEMBLY

(71) Applicant: HEWLETT-PACKARD DEVELOPMENT COMPANY, L.P., Houston, TX (US)

(72) Inventor: Craig Peter SAYERS, Palo Alto, CA (US)

(73) Assignee: HEWLETT-PACKARD DEVELOPMENT COMPANY, L.P., Houston, TX (US)

(21) Appl. No.: 16/074,409

(22) PCT Filed: Nov. 21, 2016
(86) PCT No.: PCT/US2016/063089

§ 371 Date: Jul. 31, 2018

(51) Int. Cl. B29C 64/295; H05B 1/02; G01K 1/14; B29C 64/153; B29C 64/393; B33Y 10/00; B33Y 30/00; B33Y 50/02

(52) U.S. Cl. CPC B29C 64/295; H05B 1/023; G01K 1/146; B33Y 50/02; B29C 64/393; B33Y 10/00; B33Y 30/00; B29C 64/153

(57) ABSTRACT

In an example implementation, a heating element assembly to heat a surface of a print bed includes a rotatable disc positioned over the print bed. A thermal sensor is mounted to the disc at a first radius to pass over and measure the temperature of a region of the print bed as the disc rotates. A heating element is mounted to the disc at the first radius to pass over and heat the region of the print bed when the measured temperature is below an expected temperature.

### BACKGROUND

Additive manufacturing processes can produce three-dimensional (3D) objects by providing a layer-by-layer accumulation and solidification of build material patterned from a digital model. In some examples, layers of build material can be processed using heat to cause melting and solidification of the material in selected regions of each layer. In some examples, the solidification of build material can be accomplished in other ways, such as through the use of binding agents or chemicals. The solidification of selected regions of build material can form 2D cross-sectional layers of the 3D object being produced, or printed. In some examples, layers of build material can be preheated prior to the melting and/or solidification process.

### BRIEF DESCRIPTION OF THE DRAWINGS

Examples will now be described with reference to the accompanying drawings, in which:

FIG. 1 shows an example of a 3D printing system in which an example heating element assembly may be implemented;

FIG. 2 shows additional details of an example print controller;

FIG. 3 shows additional details of an alternate example print controller;

FIG. 4 shows an example of a rotatable disc of an example heating element assembly;

FIG. 5 shows another example of a rotatable disc comprising additional pairs of thermal sensors and heating elements;

FIG. 6 shows an example of a rotatable disc that includes a thermal sensor on either side of a heating element;

FIG. 7 shows an example of multiple rotatable discs that can be rotated around different axes;

FIG. 8 shows an example of a Reuleaux mechanism pattern that can be used to move a rotatable disc within a square perimeter of a print bed; and,

FIG. 9 shows a flow diagram of an example method of heating a surface of a print bed with a heating element assembly.

Throughout the drawings, identical reference numbers designate similar, but not necessarily identical, elements.

### DETAILED DESCRIPTION

In some 3D printing processes a layer of a build material in the form of a particle material, such as powder, is spread over a platform (e.g., a print bed) within a work area. A fusing agent can be selectively applied to the material layer where the particles are to be fused together. The work area can be exposed to a fusing energy to fuse together the areas of the material layer where the fusing agent has been applied. The process can then be repeated, one layer at a time, until a part has been formed in the work area.

Once the first layer of build material has been deposited over the print bed and fused, that layer becomes the platform on which a next layer of build material is deposited. Thus, each layer becomes a platform on which the next layer is formed. In some 3D printing systems a pre-heating structure is used to pre-heat each layer of build material prior to the application of fusing energy. Each layer can be pre-heated to a uniform temperature just below the melting point of the build material.

In some examples, a pre-heating structure can include a heating element assembly mounted over the working area with heating elements pointing down at the print bed. Some heating element assemblies have arrays of fixed or rotating heating elements that are selectively controllable to provide energy in the form of heat to the working area. Such assemblies include an IR (infrared) camera that can look down at the print bed and measure the temperature across the bed. The IR camera can be centrally located on the pre-heating structure to facilitate the gathering of temperature data across the whole print bed. Measured temperature data from the IR camera can be used to control the fixed heating elements. While such structures can help to keep layers of build material pre-heated prior to fusing, use of an IR camera can be complicated and expensive, and the level of heating across the print bed can be uneven due, for example, to the fixed placement of the heating elements.

Accordingly, in some examples described herein, a heating element assembly enables a more uniform temperature across the print bed in printing systems such as 3D powder-based printers. Simple thermal sensors can be used in place of the more complex and expensive IR camera, with each sensor being in direct control of an individual heating element to gather temperature data across a specific portion of the print bed. Thermal sensor/heating element pairs can be mounted at different radii on a rotatable disc to pass over regions of the print bed. Instead of measuring temperature across the whole print bed, each thermal sensor can measure the temperature of a narrow region of the print bed and can directly control an associated heating element to maintain an expected temperature within the region. In different examples, heating element assemblies can include multiple rotatable discs having thermal sensor/heating element pairs. In some examples as discussed below, heating element assemblies can employ a Reuleaux pattern motion over the print bed and a back and forth rotation to provide even heating of the print bed with a simplified control process.

In a particular example, a heating element assembly is to heat a surface of a print bed, and the assembly includes a rotatable disc positioned over the print bed. The assembly also includes a thermal sensor mounted to the disc at a first radius to pass over and measure the temperature of a region of the print bed as the disc rotates. The assembly also includes a heating element mounted to the disc at the first radius to pass over and heat the region of the print bed when the measured temperature is below an expected temperature.

In another example, a 3D printing system includes a print bed, a powder depositor to deposit powder onto the print bed, and an agent depositor to deposit agent onto the deposited powder. The system also includes a heating element assembly to rotate a thermally controlled heating element over a region of the print bed, where the thermally controlled heating element is to sense the temperature of the region and to heat the region when the sensed temperature is below an expected temperature.

In another example, a method of heating a surface of a print bed with a heating element assembly includes positioning a rotatable disc above the print bed and mounting a thermal sensor and a heating element to the disc. The method includes rotating the disc and measuring the temperature of a region on the print bed covered by the thermal sensor, comparing the measured temperature with an expected temperature, and causing the heating element to heat the region on the print bed when the measured temperature is below the expected temperature.

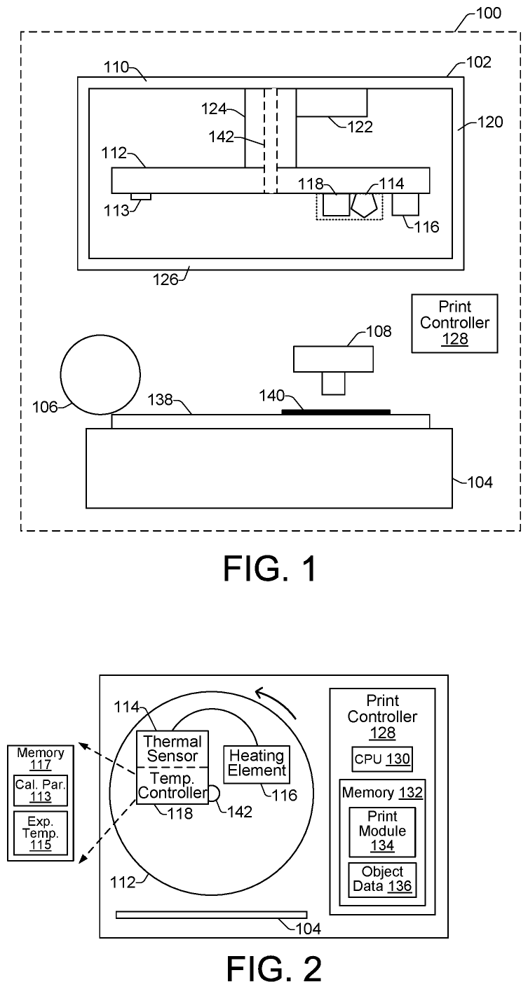

FIG. 1 shows an example of a 3D printing system 100 in which an example heating element assembly 102 may be implemented. The example 3D printing system 100 comprises a print bed, or build platform, 104, a build material distributor 106, an agent depositor 108, and a heating element assembly 102. The print bed 104 may be part of a removable build unit that can be inserted into the 3D printing system 100 for printing, and then removed when a print job is finished. The heating element assembly 102 can be mounted or otherwise positioned over the print bed 104. The heating element assembly 102 comprises a fixed portion 110 and a rotatable disc 112 hosted in the fixed portion 110. In some examples, the rotatable disc 112 can rotate at speeds on the order of one revolution per second. In some examples, the disc 112 can rotate at speeds greater than or lesser than one revolution per second. The fixed portion 110 may comprise a casing 120 to host the rotatable disc 112, a servo-mechanism 122 attached to the casing 120 and to the rotatable disc 112 with axis 124, and a protection glass 126. The rotatable disc 112 comprises a thermal sensor 114 and a heating element 116 mounted to the disc 112. In some examples, the rotatable disc 112 may additionally comprise a temperature controller 118. In some examples, the temperature controller 118 can be integrated with the thermal sensor 114. In some examples, the rotatable disc 112 comprises a calibrated disc 112 with associated calibration parameters 113 that can be stored on the disc 112 or in a memory on a controller such as temperature controller 118 or a printer controller 128, as discussed in more detail herein below.

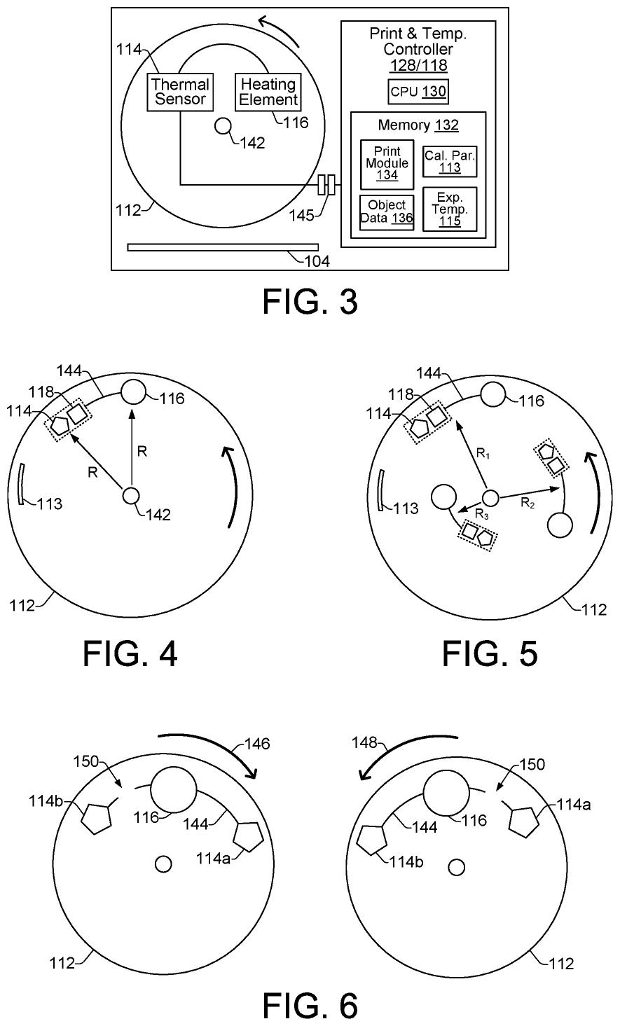

The example 3D printing system 100 additionally includes an example print controller 128. FIGS. 2 and 3 show additional details of an example print controller 128. As shown in FIG. 3, in some examples a temperature controller 118 may be implemented as part of print controller 128. Thus, in some examples the functions of the temperature controller 118 can be performed on the rotatable disc 112 as shown in FIGS. 1 and 2, while in other examples the functions of the temperature controller 118 can be performed off the rotatable disc 112 as shown in FIG. 3.

Referring generally to FIGS. 1-3, the print controller 128 can control various operations of the 3D printing system 100 to facilitate the printing of 3D objects. An example print controller 128 can include a processor (CPU) 130 and a memory 132. The print controller 128 may additionally include other electronics (not shown) for communicating with and controlling various components of the printing system 100. Such other electronics can include, for example, discrete electronic components and/or an ASIC (application specific integrated circuit). Memory 132 can include both volatile (i.e., RAM) and nonvolatile memory components (e.g., ROM, hard disk, optical disc, CD-ROM, magnetic tape, flash memory, etc.). The components of memory 132 comprise non-transitory, machine-readable (e.g., computer/processor-readable) media that can provide for the storage of machine-readable coded program instructions, data structures, program instruction modules, JDF (job definition format), 3MF formatted data, and other data and/or instructions executable by a processor 130 of the printing system 100.

An example of executable instructions to be stored in memory 132 include instructions associated with a print module 134, while examples of stored data can include object data 136. In some examples, print controller 128 can receive object data 136 from a host system such as a computer. Object data 136 can represent, for example, object files defining 3D object models to be produced on the printing system 100. Executing instructions from the build module 136, the processor 130 can generate print data for each cross-sectional slice of a 3D object model from the object data 136. The print data can define, for example, each cross-sectional slice of a 3D object model, the liquid agents to be applied to the build powder within each cross-sectional slice, and how fusing energy is to be applied to fuse each layer of powder build material. Thus, during operation, the processor 130 can control the build material depositor 106 to form a layer of build material 138 on the print bed 104. The processor can also control the agent depositor 108 to selectively deposit agent 140 on the layer of build material 138 and to apply a fusing energy to fuse the layer. The processor 130 can use the print data to control printing components of the printing system 100 to process each layer of build powder until a 3D object has been formed.

FIG. 4 shows an example of a rotatable disc 112. As noted above, the rotatable disc 112 comprises a thermal sensor 114 and a heating element 116 mounted to the disc 112. In some examples, the rotatable disc 112 may additionally comprise integrated temperature controller 118, while in some examples a temperature controller 118 may be implemented off the rotatable disc 112 as part of a print controller 128. The thermal sensor 114 can be mounted to the disc 112 at a first radius, R, from the center axis 142 around which the disc can rotate. This enables the thermal sensor 114 to pass over and measure the temperature of a region of the print bed 104 as the disc rotates. A heating element 116 can be mounted to the disc 112 at the same first radius, R, to enable the heating element 116 to rotationally follow the thermal sensor 114, and to pass over the same region of the print bed passed over by the thermal sensor 114. When the temperature controller 118 is implemented on the rotatable disc 112, electrical connections to the disc 112 may be simplified, for example, by including just a single power connection.

The thermal sensor 114 and heating element 116 can be coupled together by a control connection 144. The control connection 144 enables the thermal sensor 114, in conjunction with the temperature controller 118, to control when the heating element 116 is turned on to provide heat to the print bed 104. Using temperature data sensed or measured from thermal sensor 114 over a region of the print bed 104, the temperature controller 118 can compare the measured temperature with an expected temperature 115. An expected temperature 115 can be a pre-heating temperature that keeps the print bed 104 and material build layer 138 below a fusing temperature, but warm enough to facilitate fusing of the build layer 138 when a fusing energy is applied. The expected temperature 115 can be stored within the temperature controller 118 as an analog component of the controller 118 or in a memory 117 of the controller 118, as shown in FIG. 2. In some examples, when the temperature controller 118 is implemented off the rotatable disc 112 as part of a print controller 128, the expected temperature 115 can be stored in a memory 132 of print controller 128, as shown in FIG. 3.

As noted above, a rotatable disc 112 can comprise a calibrated disc 112 with associated calibration parameters 113. The calibration parameters 113 can be used by the temperature controller 118 or print controller 128 to accommodate for variations in thermal sensors 114 and heating elements 116 that might exist between different discs. Thus, each disc 112 in a heating element assembly 102 comprises a self-contained calibrated unit that can be replaced in the assembly 102 without the need for the printing system 100 to perform any additional calibration. Calibration parameters 113 can be stored in different ways both on and off the disc 112. For example, calibration parameters 113 can be stored electronically within the controller 118, in a memory 117 of the controller 118 (FIG. 2), or off the disc in a memory 132 of the print controller 128 (FIG. 3). Calibration parameters 113 can also be associated with a disc 112 in other ways, such as being printed, or stamped, or otherwise formed on the disc (FIGS. 1, 4, 5) to be read by a reader such as an RFID reader. In some examples, disc usage parameters can be recorded and stored either on the disc in a memory 117 of controller 118, or off the disc in a memory 132 of print controller 128. Disc usage parameters can include, for example, the number of hours a heating element/lamp 116 has been in use.

The temperature controller 118 can compare the measured temperature with the expected temperature, and based on the comparison the controller 118 can provide control signals via the control connection 144 to the heating element 116. The control signals can turn the heating element 116 on or off to provide an appropriate amount of heat to the measured region of the print bed 104 to maintain the region at the expected temperature. In some examples, as shown in FIG. 3, where the temperature controller 118 located off the rotatable disc 112 as part of the printer controller 128, the measured temperature data from the thermal sensor 114 and the control signals can be transferred between the disc 112 and the temperature controller 118 across a connection such as a slip ring connection 145.

FIG. 5 shows another example of a rotatable disc 112 that comprises additional pairs or sets of thermal sensors 114 and heating elements 116. In general, a thermal sensor 114 paired with a heating element 116 can be referred to as a thermally controlled heating element. In the FIG. 5 example, each thermal sensor 114 includes an integrated temperature controller 118. As shown in FIG. 5, each thermally controlled heating element can be mounted on the rotatable disc 112 at a different radius (e.g., R1, R2, R3) from the center axis 142 around which the disc 112 can rotate. This enables the thermal sensors 114 to pass over different regions of the print bed 104 and to measure the temperatures of the different print bed regions. Respective heating elements 116 associated with each thermal sensor 114 (i.e., coupled together by a control connection 144) are mounted to the disc 112 at respective radii to enable the heating elements 116 to rotationally follow their respective thermal sensors 114, and to pass over the same print bed region passed over by their associated thermal sensor 114.

In a manner similar to that discussed above with respect to FIG. 4, each temperature controller 118 in the FIG. 5 example can compare the measured temperature from its associated thermal sensor 114 with an expected temperature, and based on the comparison the temperature controller 118 can provide control signals via the control connection 144 to its associated heating element 116. The control signals can turn the heating elements 116 on or off to provide an appropriate amount of heat to the measured regions of the print bed 104 to maintain each print bed region at the expected temperature.

In some examples, as shown in FIG. 6, a rotatable disc 112 can include a thermal sensor 114 (114a, 114b) on either side of a heating element 116. This arrangement enables the thermal sensors and the heating element 116 to cover a region of the print bed 104 without involving complete rotations of the disc 112. Instead, the rotatable disc 112 can rotate partially (e.g., half way around) in a first direction 146 and partially in a second direction 148, opposite the first direction 146. Rotation in the first direction 146 enables a first thermal sensor 114a to measure the temperature of a first part of a region on the print bed 104 while the heating element 116 is controlled to heat the first part of the print bed region to an expected temperature. Rotation in the second direction 148 enables a second thermal sensor 114b to measure the temperature of a second part of a region on the print bed 104 while the heating element 116 is controlled to heat the second part of the print bed region to an expected temperature. The style of motion enabled by this arrangement of two thermal sensors 114 can provide a simplified electrical connection to be made to the disc 112 by a loose wire bundle that twists back and forth rather than the use of slip rings that would be used for continuous rotation of the disc 112.

Breaks 150 shown in the control connections 144 in FIG. 6 are to indicate that the thermal sensor 114 associated with that control connection 144 is inactive, or not being utilized during rotation of the disc 112 in the direction shown. For example, when the disc rotates in the first direction 146, the break in the control connection 144 associated with the thermal sensor 114b indicates that thermal sensor 114b may not be measuring the temperature of the print bed 104 at that time. The breaks 150 are not intended to indicate an actual, physical break in the control connections 144. While one arrangement of multiple thermal sensors 114 and heating elements 116 is shown in FIG. 6, other arrangements are contemplated. For example, in other arrangements the single heating element 116 can be replaced with a single thermal sensor 116, while each of the sensors 114a/114b can be replaced by two heating elements. In such an arrangement, while the disc rotates in a first direction, the single sensor can control a first heating element, and while the disc rotates in a second direction, the single sensor can control a second heating element. In yet another arrangement, a single sensor 114 and single heating element 116 can be placed on opposite sides of the disc 112, causing their relative positions to be constant regardless of the direction of the disc rotation.

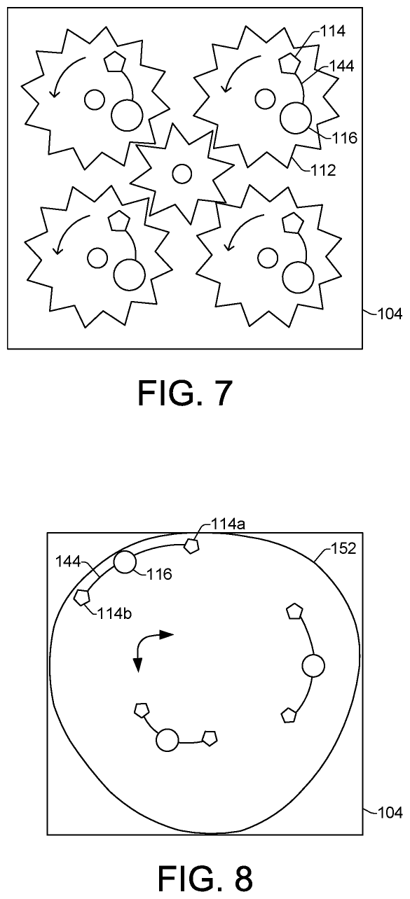

In some examples, as shown in FIG. 7, multiple rotatable discs 112 can be rotated around different axes. Each rotatable disc 112 can comprise a thermally controlled heating element comprising a thermal sensor 114 with a temperature controller 118 (not shown in FIG. 7) and a heating element 116. The thermally controlled heating elements on each disc can be positioned in the same positions on each disc in order to maintain an equal distance between the thermal sensors 114 and the heating elements 116. In addition, the discs 112 can be rotated uniformly to maintain the distances between the thermal sensors 114 and heating elements 116. The geared teeth on the edges of the rotatable discs 112 along with a center gear engaging each disc, as shown in FIG. 7, provides one example for how the discs can be rotated uniformly. Other examples can include a belt or band around the outer edges of each disc that can cause each disc to rotate uniformly when the belt is put in motion. Maintaining an equal distance between the thermal sensors 114 on the multiple discs 112 helps to ensure that temperature measurements from each thermal sensor 114 are primarily influenced by the associated heating element 116 of the respective thermally controlled heating element pair, and not by other heating elements.

In some examples, as shown in FIG. 8, a pattern of a Reuleaux mechanism can be used to move a rotatable disc within the square perimeter of the print bed 104. In general, a Reuleaux pattern comprises a curved pattern that is based on an equilateral triangle with the curve having a mostly constant width. The oblong circular shape 152 represents a Reuleaux pattern 152 in which the thermally controlled heating elements can be rotated. As shown in FIG. 8, the thermally controlled heating elements include thermal sensors 114a and 114b on either side of a heating element 116, similar to the arrangement discussed above with respect to FIG. 6. Thus, the thermally controlled heating elements in FIG. 8 can rotate on a disc 112 (not specifically shown in FIG. 8) in a back and forth motion as the disc 112 is moved around within (i.e., while positioned above) the square perimeter of the print bed 104. Moving the thermally controlled heating elements according to a Reuleaux pattern in this manner, helps to provide a uniform coverage of a square print bed 104.

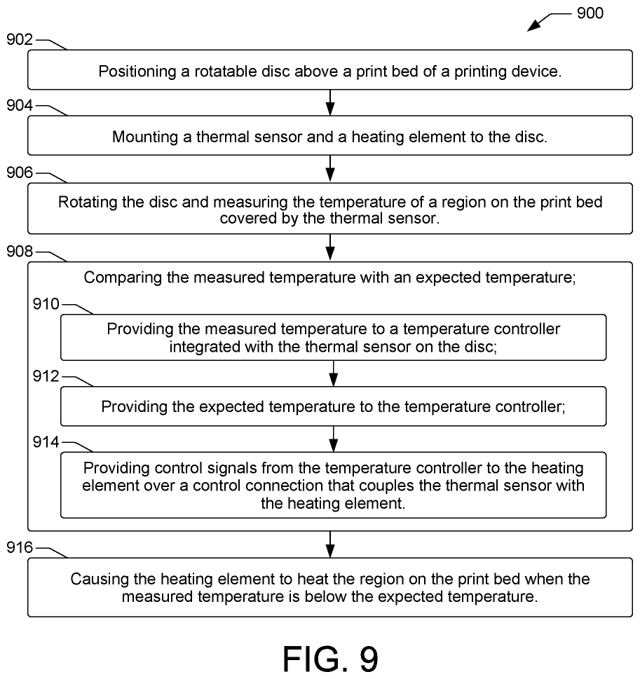

FIG. 9 shows a flow diagram of an example method 900 of heating a surface of a print bed with a heating element assembly. The method 900 is associated with examples discussed above with regard to FIGS. 1-8, and details of the operations shown in method 900 can be found in the related discussion of such examples. The operations of method 900 may be embodied as programming instructions stored on a non-transitory, machine-readable (e.g., computer/processor-readable) medium, such as memory 132 shown in FIGS. 1 and 2. In some examples, implementing the operations of method 900 can be achieved by a processor, such as a processor 130 of FIGS. 1 and 2, reading and executing the programming instructions stored in a memory 132. In some examples, implementing the operations of method 900 can be achieved using an ASIC and/or other hardware components alone or in combination with programming instructions executable by a processor 130.

The method 900 may include more than one implementation, and different implementations of method 900 may not employ every operation presented in the flow diagram of FIG. 9. Therefore, while the operations of method 900 are presented in a particular order within the flow diagram, the order of their presentation is not intended to be a limitation as to the order in which the operations may actually be implemented, or as to whether all of the operations may be implemented. For example, one implementation of method 900 might be achieved through the performance of a number of initial operations, without performing one or more subsequent operations, while another implementation of method 900 might be achieved through the performance of all of the operations.

Referring now to the flow diagram of FIG. 9, an example method 900 of heating a surface of a print bed with a heating element assembly begins at block 902 with positioning a rotatable disc above a print bed of a printing device. The method includes mounting a thermal sensor and a heating element to the disc, as shown at block 904. As shown at block 906, the method includes rotating the disc and measuring the temperature of a region on the print bed covered by the thermal sensor. The measured temperature can then be compared with an expected temperature as shown at block 908. In some examples, comparing the measure temperature with the expected temperature can include providing the measured temperature to a temperature controller integrated with the thermal sensor on the disc, providing the expected temperature to the temperature controller, and providing control signals from the temperature controller to the heating element over a control connection that couples the thermal sensor with the heating element, as shown at blocks 910, 912, and 914, respectively. As shown at block 916, the method 900 can then include causing the heating element to heat the region on the print bed when the measured temperature is below the expected temperature.

What is claimed is:

1. A heating element assembly to heat a surface of a print bed, the assembly comprising:
a rotatable disc positioned over the print bed;
a thermal sensor mounted to the disc at a first radius to pass over and measure the temperature of a region of the print bed as the disc rotates; and,
a heating element mounted to the disc at the first radius to pass over and heat the region of the print bed when the measured temperature is below an expected temperature.

2. A heating element assembly as in claim 1, further comprising:
a temperature controller to compare the measured temperature with the expected temperature, and based on the comparison, to provide a control signal to control the heating element to heat the region of the print bed; and,
a control connection to carry the control signal from the thermal sensor to the heating element.

3. A heating element assembly as in claim 2, wherein the rotatable disc comprises a calibrated disc with associated calibration parameters stored in a location selected from the group consisting of a printing made on the disc, a stamp made on the disc, the temperature controller on the disc, a memory of the temperature controller on the disc, and a memory of a print controller off the disc.

4. A heating element assembly as in claim 1, wherein the heating element and the thermal sensor are oriented on the disc so that the heating element follows the thermal sensor in passing over the region of the print bed.

5. A heating element assembly as in claim 1, further comprising:
a second thermal sensor mounted to the disc at a second radius to pass over and measure the temperature of a second region of the print bed as the disc rotates; and,
a second heating element mounted to the disc at the second radius to pass over and heat the second region of the print bed when the measured temperature of the second region is below an expected temperature.

6. A heating element assembly as in claim 1, wherein the rotatable disc comprises multiple rotatable discs, and wherein:
each rotatable disc comprises a thermal sensor and heating element oriented thereon in a same manner; and
each rotatable disc is rotatable about a separate axis and in unison with each other rotatable disc such that distances between the heating elements and distances between the thermal sensors do not change as the discs rotate.

7. A heating element assembly as in claim 1, further comprising another thermal sensor mounted to the disc at the first radius, the thermal sensor and the other thermal sensor located on either side of the heating element, wherein:
the rotatable disc is rotatable back and forth in first and second directions;
the thermal sensor is active to measure the temperature of the region of the print bed as the rotatable disc rotates in the first direction; and,
the other thermal sensor is active to measure the temperature of a second region of the print bed as the rotatable disc rotates in the second direction.

8. A heating element assembly as in claim 1, wherein the rotatable disc is to move within the perimeter of the print bed following a Releaux pattern.

9. A 3D printing system comprising:
a print bed;
a powder depositor, to deposit powder onto the print bed;
an agent depositor, to deposit agent onto the deposited powder; and,
a heating element assembly to rotate a thermally controlled heating element over a region of the print bed, the thermally controlled heating element to sense the temperature of the region and to heat the region when the sensed temperature is below an expected temperature.

10. A 3D printing system as in claim 9, wherein the heating element assembly comprises:
multiple thermally controlled heating elements each mounted at a different radius on a rotatable disc positioned over the print bed, and each thermally controlled heating element to sense the temperature of a different region of the print bed and to heat the different region when the sensed temperature of the different region is below the expected temperature.

11. A 3D printing system as in claim 10, wherein the heating element assembly comprises multiple rotatable discs positioned over the print bed and rotatable about different axes of rotation.

12. A 3D printing system as in claim 11, wherein each rotatable disc comprises a thermally controlled heating element mounted to the disc in a same orientation as each other disc.

13. A 3D printing system as in claim 12, wherein the multiple rotatable discs are to be rotated uniformly with one another around their respective axes of rotation.

14. A method of heating a surface of a print bed with a heating element assembly, the method comprising:
positioning a rotatable disc above the print bed;
mounting a thermal sensor and a heating element to the disc;
rotating the disc and measuring the temperature of a region on the print bed covered by the thermal sensor;
comparing the measured temperature with an expected temperature; and,
causing the heating element to heat the region on the print bed when the measured temperature is below the expected temperature.

15. A method as in claim 14, wherein comparing the measured temperature with an expected temperature comprises:
providing the measured temperature to a temperature controller integrated with the thermal sensor on the disc;
providing the expected temperature to the temperature controller; and,
providing control signals from the temperature controller to the heating element over a control connection that couples the thermal sensor with the heating element.
